(19) United States
(12) Patent Application Publication
(10) Pub. No.: US 2011/0119703 A1
(43) Pub. Date: May 19, 2011

(54) METHOD AND APPARATUS FOR DELIVERING SDV UNICAST PROGRAMMING WITH TARGETED ADVERTISING ON A BANDWIDTH-AVAILABLE BASIS

(75) Inventors: John A. Schlack, Quakertown, PA (US); Bruce R. Bradley, Wayne, PA (US)

(73) Assignee: GENERAL INSTRUMENT CORPORATION, Horsham, PA (US)

(21) Appl. No.: 12/620,575

(22) Filed: Nov. 17, 2009

(51) Int. Cl. H04N 7/025; H04N 7/173; H04L 12/56

(52) U.S. Cl. 725/34; 725/96; 370/390; 725/35

(57) ABSTRACT

A switched digital video (SDV) system includes an SDV manager for coordinating a SDV session requested by a subscriber terminal. The system also includes a plurality of edge devices for receiving a transport stream that includes programming content and transmitting the transport stream over an access network to the subscriber terminal on one of a plurality of SDV channels. The SDV manager is configured to monitor bandwidth and cause the edge device to deliver the SDV session to the subscriber terminal in a SDV unicast stream when sufficient unused bandwidth is available or as a SDV multicast stream when sufficient unused bandwidth is not available.

### FIELD OF THE INVENTION

The present invention relates generally to a switched digital video system for distributing content to a subscriber over a system such as a satellite or cable television system, and more particularly to a switched digital video system in which advertising can be targeted to selected groups of subscribers.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on-demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize a session manager to manage SDV sessions. The subscriber will set up an SDV session with the session manager when an SDV program is requested. The session manager will determine if the requested channel is already being sent to the corresponding service group that the subscriber belongs to. The subscriber will be assigned to join the existing SDV session if the requested channel is available at the service group or assigned to a new SDV session if the requested channel is not available at the service group. The Session Manager will negotiate with the edge devices to allocate resources required for the session. The edge device (e.g., a digital modulator such as a QAM modulator) needs to dynamically retrieve the MPEG single program transport stream that carries the requested broadcast program (typically via IP unicast or multicast) and generates the MPEG multiple program transport stream. As part of the session setup response message, the video tuning parameters such as frequency and MPEG program number are sent back to the subscriber to access the requested broadcast channel.

As with other types of broadcast programming, advertising forms an important part of SDV programming. The revenues generated from advertisers subsidize and in some cases pay entirely for the programming. Even in subscriber-based television systems such as cable and satellite television systems, the revenues from advertisements subsidize the cost of the programming, and were it not for advertisements, the monthly subscription rates of such systems could be many times higher than at present.

Traditional broadcast television systems broadcast the same television signal to each person viewing a particular station. Thus, each person viewing a particular channel will necessarily view the same programming content as well as the same advertisements embedded in the programming content. However, with modern digital television systems such as SDV systems more personalized television service is possible. For instance, in SDV systems, a group of subscriber households can be selectively addressed through a cable node serving that group. Similarly, individual subscriber households can be selectively addressed though their set top terminals. In other words, the service provider can send different data to different subscribers or groups of subscribers.

Typically, a particular advertiser will purchase a particular “spot”, i.e., an advertising opportunity in a particular channel at a particular time, based on the likelihood that members of that advertiser's target audience will be watching that particular channel at that particular time. For instance, advertisers typically have a particular demographic group of individuals that they wish to reach with their advertising. For example, the manufacturer of a low-cost beer probably has a primary target audience of males between the ages of 21 and 39, living in households with a household annual income of less than $75,000 per year. As another example, a manufacturer of laundry detergent may have a primary target audience of women between 19-59 years of age with no particular preference regarding household income. As another example, a manufacturer of expensive beer may wish to have a target audience similar to that of the manufacturer of low-cost beer in that it comprises males between the ages of 21 and 39. However, this manufacturer's target demographic audience may include a different economic profile, e.g., males between the ages of 21 and 39, living in households with annual household incomes of over $60,000 per year. Another advertiser that manufactures children's toys appropriate for children between 5 and 10 years of age might have a target audience of children between the ages of 5 and 10 and, depending upon the particular toys, a desired annual household income range.

In terms of advertising, SDV systems can allow each set top terminal to receive its own copy of a channel. More specifically, when a set top terminal in a particular service group requests an SDV program, the SDV manager can direct the headend to deliver a unicast video stream to a particular port on the QAM modulator servicing the set top terminal that made the request. The QAM modulator, in turn, delivers a single copy of the channel supporting the unicast video stream to the appropriate service group. The SDV manager then directs the set top terminal that made the request to tune to that particular channel supporting the unicast video stream by sending a force tune message. This process used to unicast an SDV channel is similar to the process used in video on demand (VOD) since in both cases each set top terminal receives its own copy of the channel. Such an approach is sometimes referred to as SDV unicasting.

Since SDV unicasting can provide each set top terminal with its own copy of a channel, it allows different renditions of a program to be sent to different set top terminals. Each rendition, which can include different advertising targeted to each individual set top terminal, is carried on a different unicast stream between the headend and the hubs. Unfortunately, a large bandwidth is needed when unicasting SDV channels. In fact, with SDV unicasting there may be no bandwidth savings at all when multiple viewers request the same SDV programming. As a result, the bandwidth required to provide many dedicated channels at peak viewing times can be much greater than the available RF spectrum between the hub and the set top terminals. This problem can be overcome by deploying more QAM modulators to reduce the size of the service groups, but this approach is time-consuming and expensive.

### SUMMARY

In accordance with one aspect of the invention, a switched digital video (SDV) system is provided which includes an SDV manager for coordinating a SDV session requested by a subscriber terminal. The system also includes a plurality of edge devices for receiving a transport stream that includes programming content and transmitting the transport stream over an access network to the subscriber terminal on one of a plurality of SDV channels. The SDV manager is configured to monitor bandwidth and cause the edge device to deliver the SDV session to the subscriber terminal in a SDV unicast stream when sufficient unused bandwidth is available or as a SDV multicast stream when sufficient unused bandwidth is not available.

In accordance with another aspect of the invention, a method for providing SDV programming to subscribers includes monitoring unused bandwidth of an access network between one or more edge devices and a plurality of subscriber terminals. At least a first of the subscriber terminals tuned to a SDV multicast rendition of a program that is delivered over the access network is caused to tune to a first SDV unicast rendition of the program when sufficient bandwidth is available on the access network.

### BRIEF DESCRIPTION OF THE DRAWINGS

FIG. 1 shows one example of a system architecture for delivering switched digital video content to a subscriber.

FIGS. 2 and 3 show examples of a headend that can be used to deliver SDV programming to target groups of subscribers.

FIG. 4 illustrates the process of SDV multicasting between a headend and a hub.

FIG. 5 shows one example of a set top terminal

FIG. 6 is flowchart showing one example of a method for providing SDV programming with advertising that is directed to target groups of subscribers.

### DETAILED DESCRIPTION

The selective addressability of modern digital television service systems renders more targeted TV advertising possible. As a result, demographic data may be used to provide different subscribers of the same television program different advertisements that are particularly directed to them. In order to effectively target advertising to subscribers it is necessary to understand certain attributes of the target subscriber, such as demographic and psychograph attributes, and to acquire any data relevant to determining the appropriateness of an ad for the particular subscriber. Such data can include past viewing habits, previous purchasing selections, self-reporting through, e.g, user profiles, and the like.

As previously mentioned, advertising can be precisely targeted to individual subscribers when switched digital video (SDV) unicasting is employed, but only with a significant increase in the amount of bandwidth that is required. As detailed below, a method is provided for delivering SDV programming with advertising that is less precisely targeted whenever there is insufficient bandwidth to target individual subscribers. For instance, targeted advertising can be provided at the level of the service group instead of at the individual subscriber level. In this case all subscribers in the same service group will receive the same rendition of an SDV program with the same advertising. However, when there is unused or excess bandwidth available, some of those subscribers can be provided with their own renditions of a program, which can contain ads targeted to their precise demographic and other attributes, by delivering the program using SDV unicasting.

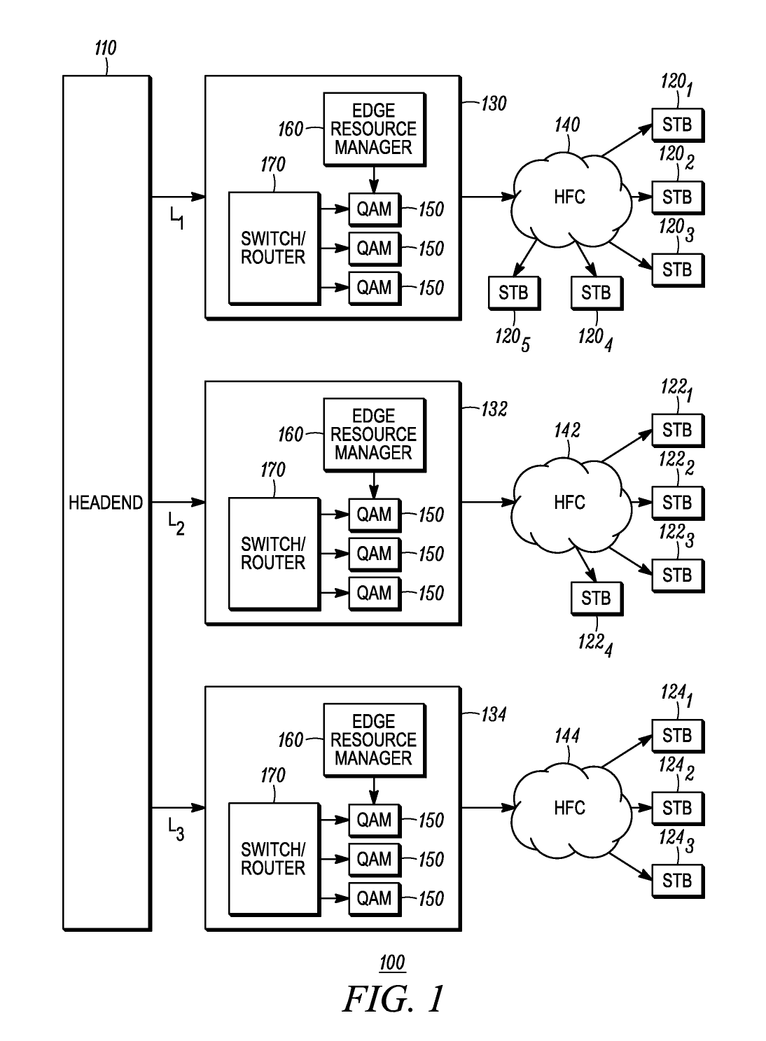

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast or unicast addressing. Details concerning multicast and unicast addressing as they pertain to targeted advertising will be presented below. As used herein, advertising refers to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110.

When a viewer selects an SDV program using a subscriber terminal such as a set top terminal, the SDV system actively switches the channel carrying that program onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the SDV channels. SDV service groups currently include from about 500 to 1000 set top terminals. Depending on the system topology, there may or may not be a one-to-one correspondence between the hubs and the service groups. For instance, it is typically the case that each hub serves multiple service groups. Finally, the SDV manager sends a force tune message to the set top terminal forcing it to tune to the channel on which the selected program is being carried.

SDV programming and the advertisements associated therewith may be supplied by a multicasting technique or a unicasting technique. If SDV multicasting is employed, when a set top terminal in a particular service group requests an SDV program, the SDV manager directs the QAM modulator servicing that particular service group to issue an Internet Group Management Protocol (IGMP) Join request to receive the multicast stream. The QAM modulator then delivers a single copy of the channel supporting the program to that service group. The SDV manager directs the set top terminal that made the request to tune to the appropriate channel. Any other set top terminals in the same service group which request the same programming are also directed to tune to that channel. That is, when multicasting is employed, a single video stream is provided from the headend to the hub and the video stream is carried on a single channel from the hub to the appropriate service group. Accordingly, multicasting minimizes bandwidth usage between the headend and the hub as well as between the hub and service group.

In terms of advertising, SDV multicasting allows different renditions of a program to be sent to different service groups. Each rendition, which can include different advertising targeted to the set top terminals in those service groups, is carried on a different multicast stream between the headend and the hubs. Stated differently, the multicasting of SDV programming allows advertising to be targeted down to the granularity of a service group. That is, each set top terminal in a service group can receive a rendition of an SDV channel tailored to that service group.

On the other hand, as previously noted SDV unicasting allows a different rendition of a program to be sent to each individual set top terminal in a service group since each terminal receives its own copy of a program. That is, the unicasting of SDV programming allows targeted advertising down to the granularity of a set top terminal Unfortunately, the price of this fine degree of granularity is that a large amount of bandwidth is needed.

In order to offer more targeted advertising than is possible by the exclusive use of SDV multicasting without the need to deploy additional edge devices to increase bandwidth, SDV unicasting may be used to deliver programming to selected subscribers only when excess or unused bandwidth is available. Other subscribers will continue to receive programming using SDV multicasting. Since SDV systems are typically designed with a sufficient number of QAMs per service group to allow for peak viewership and a peak diversity in the channels being viewed, there generally will be unused bandwidth available whenever the system is not operating during peak periods. A higher precision in advertising delivery can thus be achieved by using SDV multicasting in combination with SDV unicasting whenever the necessary bandwidth is available.

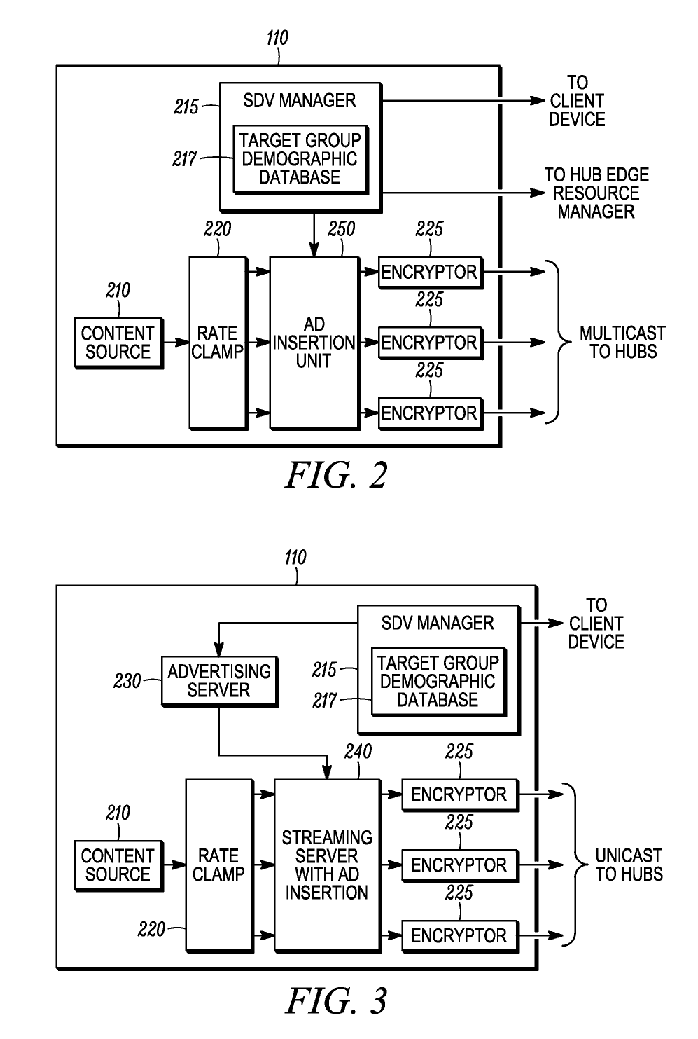

FIGS. 2 and 3 show two examples of headend 110. The example presented in FIG. 2 is often associated with a headend that multicasts programming to the hubs while the example in FIG. 3 is often associated with a headend that unicasts programming to the hubs. More generally, however, each headend can be used to distribute programming in accordance with either a multicasting or unicasting technique. It should be noted that in these examples ad insertion is performed in the headend. More generally, however, ads may be inserted into SDV program streams at other locations as well. For example, in some implementations the QAMs may include an ad insertion module to insert ads into the SDV program streams received from the headend. A QAM that incorporates such an ad insertion module is shown in [Docket No. BCS05017], which is hereby incorporated by reference in its entirety.

Referring to FIG. 2, the headend 110 includes a broadcast content source 210, which may include, by way of example, satellite receivers, off-air receivers and/or content storage devices such as servers. An SDV manager 215 is used to determine which SDV transport streams are active at any time and for directing the set top terminals to the appropriate stream with the use of force tune messages. The SDV manager 215 also keeps track of which subscribers are watching which channels and it communicates with the edge resource managers 160 (see FIG. 1) in the hubs so that the content can be switched on and off under the control of the SDV manager 215. In addition, all subscriber requests for a switched digital channel go through the SDV manager 215. Content is forwarded by the content source to a rate clamp 220 and an ad insertion module 250 that operates under the control of the SDV manager 215. In the case of multicasting, the ads are selected based on demographic and other information concerning the service group to which the content is being forwarded. The ad insertion module 250 operates under the control of the SDV manager 215, which in turn selects the ads based on the information in the target group demographic database 217. The content is then encrypted by one or more encryptors 225 and transmitted to the appropriate hub or hubs using, in this example, multicast addressing. The encryptors 225 encrypt the digitally encoded content, often under the control of a conditional access system (not shown).

It should be noted that the headend 110 shown in FIG. 2 as well as in FIG. 3, may also include a variety of other components for offering additional services. For example, the headend 110 may comprise typical head-end components and services including a billing module, a video-on-demand (VOD) server, a subscriber management system (SMS), a conditional access system and a LAN(s) for placing the various components in data communication with one another. Also, although not shown, one of ordinary skill in the art would recognize that other components and arrangements for achieving the various functionalities of headend 110 are possible. It will also be appreciated that the headend configurations depicted in FIGS. 2 and 3 are high-level, conceptual architectures and that each system may have multiple head-ends deployed using different architectures.

Referring now to the headend 110 depicted in FIG. 3, the headend 110 once again includes a broadcast content source 210 and an SDV manager 215. Content is forwarded by the content source to a rate clamp 220, a streaming server 240 and one or more encryptors 225. The streaming server 240 stores the content and inserts ads into the programming that are provided by ad server 230. The advertising server 230 operates under the control of the SDV manager 215. The SDV manager 215 determines the appropriate ads to be inserted at the appropriate times in the programming. The content is then encrypted by the encryptors 225 and transmitted to the appropriate hub or hubs using, in this example, unicast addressing.

To implement SDV multicasting, multiple renditions of a program are created—one rendition for each service group. Each rendition will include different advertising based on the characteristics of the service group. To this end, as shown in FIGS. 2 and 3, the SDV manager 215 includes a target group demographic database 217 that specifies the demographics of each service group.

The demographic data located in the database 217 can be acquired in any of a variety of different ways. For example, subscriber viewing history, subscriber geography and subscriber self-reporting in response to questionnaires and the like may all be used to populate the target group demographic database 217. Of course, target group demographic database 217 need not necessarily physically reside in the SDV manager 215, but rather may be discrete or combined with other components. In addition, while in FIGS. 2 and 3 the database 217 is located in the headend, the database 217 more generally may reside in any suitable location within the SDV system. For example, in some cases it may be convenient to locate the target group demographic database 217 in the hubs.

The various renditions of the program specified by the SDV manager 215 are all multicast from the headend to the hubs. When a set top terminal requests the program, the SDV manager directs the edge device servicing that set top terminal to issue an IGMP join request to receive the appropriate multicast stream for that particular set top terminal. The appropriate multicast stream is the stream that includes the rendition of the program that matches the service group to which the set top terminal belongs. For example, returning to an earlier example, one rendition of the program may include an advertisement for low-cost beer. This rendition may be directed to a service group that includes a significant number of males between the ages of 21 and 39 living in a household with annual incomes of less than $75,000 per year who spend more than 50% of their viewing time watching sporting events

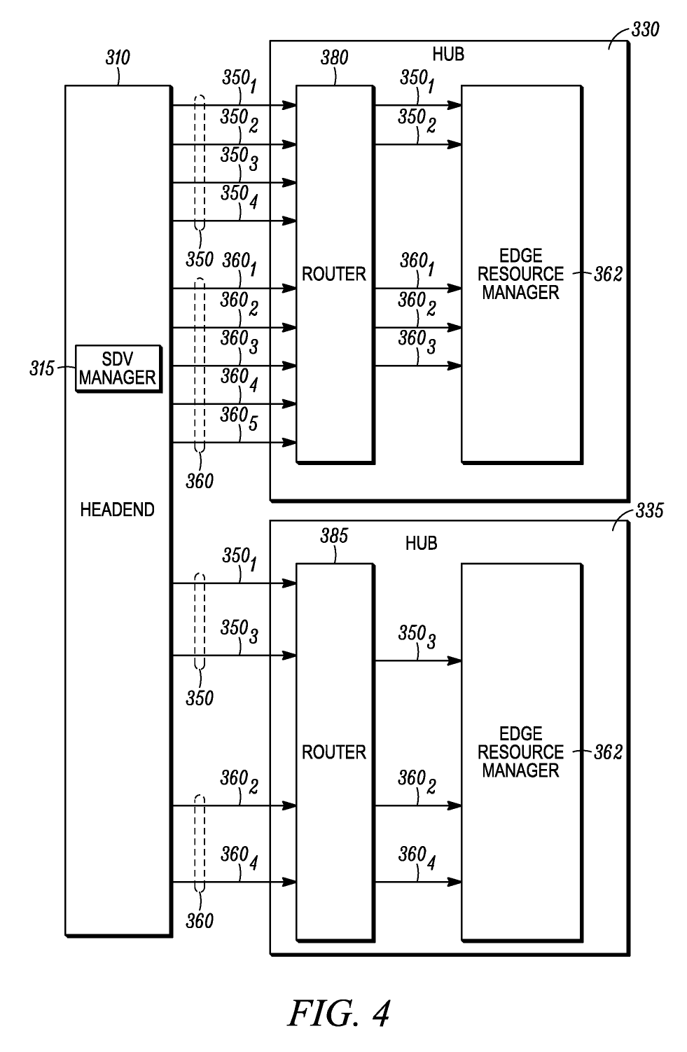

After the edge device has been directed to receive the multicast stream that includes the appropriate rendition of the programming, the edge device delivers a single copy of the channel containing the content of the multicast stream to the service group to which the set top terminal that made the request belongs. Finally, the SDV manager directs the set top terminal to tune to the channel on which the programming is available. FIG. 4 illustrates this process of multicasting SDV channels.

Referring to FIG. 4, two programs are multicast from the headend 310 to hubs 330 and 335 via routers 380 and 385, respectively. One program is represented by multicast streams 350 and the other program is represented by multicast streams 360. The individual multicasts streams 350₁, 350₂ and 350₃ include different renditions of the same programming. Each rendition is tailored to a different service group of set top terminals. When a set top terminal in say, service group 2 requests a program supported by multicast streams 350, the SDV manager 315 determines which target group the set top terminal belongs. The SDV manager 315 directs the edge device (via the edge resource manager 362) to issue a IGMP join request to receive the particular one of the multicast streams 350 that is intended for that service group. For example, the set top terminal serviced by hub 330 and making the request may belong to a service group associated with the rendition of the program supported on multicast stream 350₂. In this case the edge device receives the multicast stream 350₂ after issuing the IGMP request and forwards it to service group 2 on an appropriate channel. In this case router 380 would only forward multicast stream 350₂ to the hub 330. The SDV manager 315 directs the set top terminal to tune to this channel. Likewise, if another set top terminal serviced by hub 330 in service group 2 requests the same programming, it too will be directed to tune to this channel. Similarly, as shown in FIG. 4, if set top terminals serviced by hub 335 request multicast streams 350₃, 360₂ and 360₄, these streams are forwarded to hub 335 via router 385.

If SDV unicasting as described above is used instead of SDV multicasting, an essentially unlimited number of renditions of a program can be provided. Therefore, very precise targeting of subscribers can be achieved down to the level of an individual set top terminal, although larger target groups may also be employed. Another advantage of SDV unicasting is that the number of target groups and the criteria used to define them can be dynamically adjusted. Since the SDV manager 215 controls in real time the ads that are being inserted into the programming as the program is being streamed from the streaming server 240, the SDV manager 215 can even adjust or rearrange the target groups based on its knowledge of the upcoming ads that are to be inserted from the advertising server 230. Once the SDV manager 215 redefines one or more target groups based on an upcoming ad, the set top terminals that are affected can be directed by the SDV manager to tune to the appropriate new channel for their target group.

In order to determine when it may be appropriate to switch selected set top terminals from receiving SDV multicast sessions to receiving SDV unicast sessions, the edge resource manager 160 shown in FIG. 1 monitors the bandwidth that the edge devices (e.g., QAMs 150) have available. The edge resource manager 160 tracks the available or unused bandwidth and alerts the SDV manager 215 when bandwidth to the various service groups becomes available to initiate one or more unicast sessions. The edge resource manager 160 also alerts the SDV manager 215 when bandwidth to the various service groups needs to be reclaimed from one or more SDV unicast sessions so that it can be used for other purposes.

The SDV manager 160 may use the bandwidth information it receives from the edge device or devices in any manner to assign and terminate unicast sessions. For instance, the SDV manager 160 may passively use this information to assign switched unicast sessions whenever subscribers change channels. When the SDV manager 160 receives a channel change request from a set top terminal, and the requested channel is already being viewed by one or more subscribers in the service group, the SDV manager 160 decides whether to assign a unique unicast stream to the subscriber or whether to assign the subscriber to an existing multicast stream that is already being delivered to that service group. The one or more subscribers who are selected to receive an SDV unicast session may be based not only on the available bandwidth, but on other factors as well. For instance, as determined from the target group demographic database 217, some subscribers may be more desirable candidates for receiving targeted advertising than other subscribers. In this case, if only a limited number of the subscribers switching channels can be accommodated with a unicast session, only the more desirable subscribers will be switched. The most desired subscribers can be selected based on a variety of factors. For example, such subscribers may be those subscribers who are anticipated to generate the highest advertising revenue as a result of receiving a targeted advertisement.

Alternatively, the SDV manager 160 may actively use the available bandwidth information to establish switched unicast sessions for existing subscribers, even when they are not requesting a channel change. In this case the SDV manager 160 first identifies an appropriate number of high value subscribers in a service group based on the available bandwidth and the programming they are currently receiving. The SDV manager 160 then causes additional renditions of the programming to be created for each of the subscribers who are selected. The SDV manager 160 sends a force tune message to the appropriate set top terminals to force them to tune to the respective channel on which their respective rendition of the SDV unicast program is being delivered.

When establishing a new SDV unicast session, the edge resource manager will attempt to place the service on the same edge device that is already delivering the program to the subscriber using SDV multicasting. In this way the subscriber's set top terminal does not need to tune to a new RF frequency, but rather only needs to access the new MPEG program information associated with the SDV unicast session. This so-called “QAM affinity” enables the set top terminal to switch to the SDV unicast session in a faster and smoother manner than it could if it had to tune to a different RF frequency. In fact, such a switch to the SDV unicast session may even appear seamless to the subscriber. This faster response occurs because set top terminals can access new program information in significantly less time than is needed to tune to a new RF frequency.

When the SDV manager 160 determines that one or more unicast sessions need to be terminated because the bandwidth is needed for other purposes, it will examine the subscribers who are currently receiving unicast sessions and who belong to the service group in communication with the edge device on which the bandwidth is needed. This determination may be performed on any appropriate basis. For instance, heuristics may be used to select the unicast sessions that should be released. For example, the SDV manager may reclaim unicast sessions that do not have immediately upcoming ad opportunities, thus maximizing the revenue potential of the remaining unicast streams that will have ads inserted in the immediate future. The SDV manager 160 may also use the information available in the target group demographic database 217 to assist in the selection of those subscribers whose unicast session should be terminated.

Similar to the initiation of a unicast session, a unicast session may be terminated to reclaim bandwidth by sending a force tune message when the subscriber changes channels. This termination method will generally be the most transparent to the subscriber. Alternatively, a switched unicast session can be terminated by sending the force tune message when the next ad insertion point arrives in the unicast program. This termination method may be somewhat less transparent to the subscriber, though it should still be relatively imperceptible to the subscriber if QAM affinity has been achieved. Another method to terminate a unicast session, and the most aggressive and potentially most perceptible to the subscriber, is to send a force tune message to the subscriber's set top terminal in mid-program. Terminating the session in this way will not be concealed by the presentation of black frames and could appear to be abrupt. However, even this disruption can be minimized if the subscriber is directed to a multicast rendition of the program that is being transmitted by the same QAM or other edge device on which the unicast rendition of the program was being transmitted.

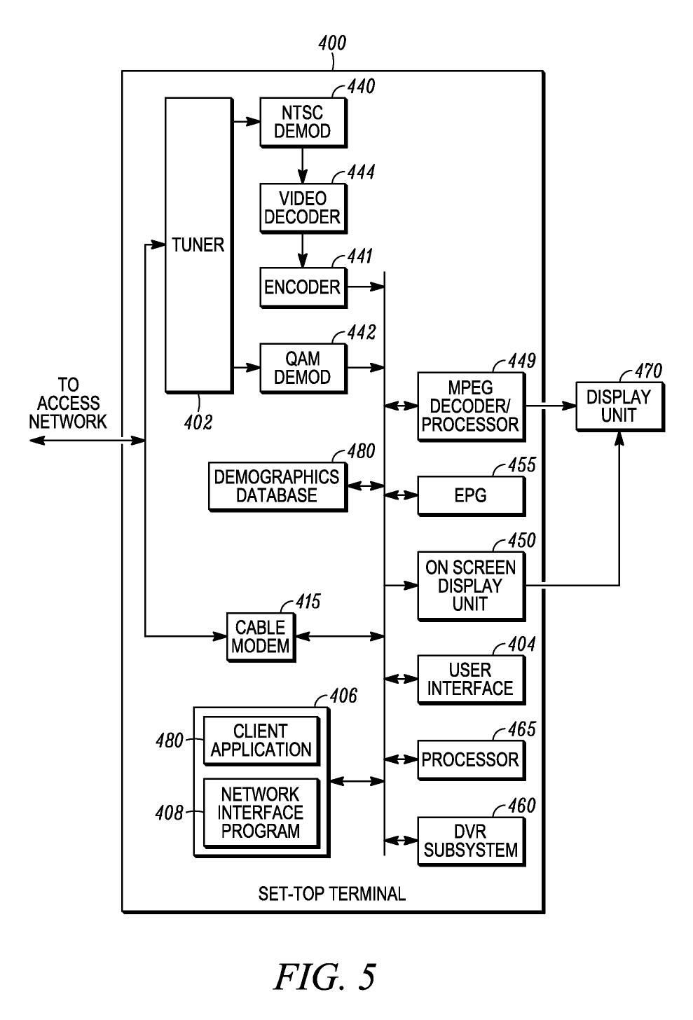

One example of a set top terminal 400 is shown in more detail in FIG. 5. It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from cable access networks seen in FIG. 1. Broadly speaking, a traditional set top terminal such as that depicted in FIG. 5 is a device that can receive, store and forward content without manipulating the content in any significant way except to format it so that it may be rendered in a suitable manner.

Set-top terminal 400 includes an in-band tuner 402, which tunes to a channel signal selected by a consumer (not shown) via user interface 404. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques. Video decoder 444 is responsive to receive and decode video information. Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two transport streams (for example, video and audio).

An electronic program guide (EPG) 455 is also provided in set-top terminal 400. The EPG 455 is an interactive, on-screen display feature that displays information analogous to TV listings found in local newspapers or other print media. An EPG provides information about each program being broadcast within the time period covered by the EPG, which typically ranges from the next hour up to several days. The information contained in an EPG includes programming characteristics such as, for example, channel number, program title, start time, end time, elapsed time, time remaining, a brief description of the program's content and possibly the names of individuals associated with the program such as the actors, writers and director. The EPG, which is generally received along with the programming content, may be updated on a periodic basis so that the consumer can make appropriate selection for upcoming programs. For example, the electronic program guide 455 may display programs in a tabular format by channel and time so that the user can make selections of desired content. In some cases, instead of transmitting it along with the programming, the electronic program guide 455 may be downloaded via a telephone line, cable connection, satellite up-link, or radio broadcast antenna.

An on-screen display unit 450 is provided in set top terminal 400. The on-screen display unit 450 is used to display information such as control menus and the like as well as information received from the service provider or MSO that needs to be directly presented to the user regardless of the particular programming or channel that the user is currently viewing. In particular, on-screen display unit 450 displays the information provided by the EPG 455. Accordingly, on-screen display unit 450 can forward the information directly to the display unit 470, where it may appear as an overlay, pop up, or scrolling text ticker that is superimposed on the current programming being viewed. Alternatively, the information from the on-screen display unit 450 may even replace the current programming that appears on the display unit 470.

DVR subsystem 460 is provided for recording programs received from the access network. DVR subsystem 460 can control the channel tuned by tuner 402 and record programming on a manual or timer control basis. Additionally, the DVR subsystem 460 can buffer incoming programs to enable a view to pause or replay a portion of a live program.

Set-top terminal may also optionally include a demographics database 490 to store the demographic information concerning the subscriber that is to be sent to the headend.

Set-top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs (e.g., an SDV application) may reside on storage medium 406. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a broadband system.

The various components of set top terminal 400 discussed above may all operate under the overall control of a processor 465. Moreover, it is contemplated that the processor 465, tuner 402, video decoder 449, user interface 404, onscreen display unit 450 and the other components shown in FIG. 5 may each be implemented in hardware, software or a combination thereof. In addition, although the various components are shown as separate processors, it is contemplated that they may be combined and implemented as separate processes on one or more processors.

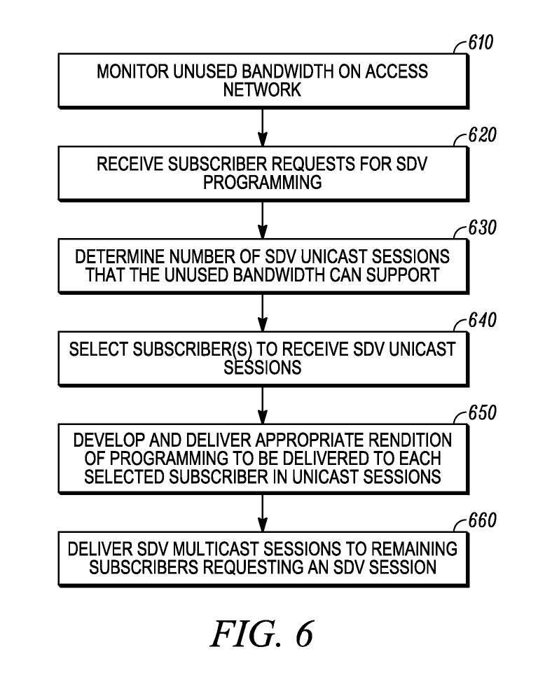

FIG. 6 is a flowchart showing one example of a method for providing SDV programming to subscribers. The method begins in step 610 when the SDV manager monitors the unused bandwidth available on the access network between the edge devices and the subscribers. Monitoring may be performed in a number of different ways. For instance, the edge resource manager, which allocates SDV program streams among the various edge devices, may continuously update the SDV manager on bandwidth usage. Alternatively, the edge resource manager may simply notify the SDV manager whenever some minimum amount of bandwidth becomes available. Next, in step 620, one or more subscribers request SDV programming by sending a channel change request to the SDV manager. The SDV manager determines how many unicast sessions, if any, can be delivered over the access network at this point in time in step 630. The SDV manager then selects in step 640 one or more subscribers who are to receive the SDV programming in a SDV unicast session. The number of subscribers that are selected is equal to or less than the number of unicast sessions that the SDV manager has determined can be supported. The selection of the subscribers is based at least in part on demographic or other attributes of the individual subscribers. Next, in step 650, the SDV manager develops an appropriate rendition of the SDV program requested by each subscriber, which is tailored for each subscriber who is to receive an SDV unicast session. The various renditions are delivered to their respective subscribers as an SDV unicast session. Each rendition may include one or more ads that selected in part based on the demographic or other attributes of the particular subscriber who is to receive it. If there are additional subscribers requesting SDV programming who cannot be accommodated with an SDV unicast session, then in step 660, they are provided with an SDV multicast session that includes the appropriate programming

Among its other advantages, the system and techniques described herein allow SDV unicast sessions to be delivered to subscribers by using underutilized network resources, thus allowing precisely targeted advertising to be presented whenever possible without the need to deploy additional infrastructure such as QAM modulators.

The processes described above, including but not limited to those presented in connection with the headend and set-top terminal may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable storage medium. The instructions may also be created using source code or any other known computer-aided design tool. A computer readable storage medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
monitoring unused bandwidth of an access network between one or more edge devices and a plurality of subscriber terminals; and
causing at least a first of the subscriber terminals tuned to a SDV multicast rendition of a program that is delivered over the access network to tune to a first SDV unicast rendition of the program when sufficient bandwidth is available on the access network.

2. The computer-readable medium of claim 1 further comprising causing the first subscriber terminal to tune back to the SDV multicast rendition of the program when bandwidth on the access network needs to be reclaimed for other purposes.

3. The computer-readable medium of claim 1 causing a second of the subscriber terminals tuned to the SDV multicast rendition of the program to tune to a second SDV unicast rendition of the program when sufficient bandwidth is available on the access network, wherein the first and second SDV unicast renditions include a common program and one of more advertisements that are different from one another.

4. The computer-readable medium of claim 3 wherein the different advertisements are selected based on attributes pertaining to the subscribers associated with each of the subscriber terminals.

5. The computer-readable medium of claim 4 wherein the attributes include demographic information concerning each subscriber.

6. The computer-readable medium of claim 1 further comprising causing the first subscriber terminal to tune to the SDV multicast rendition after receiving a channel change request from the first subscriber terminal.

7. The computer-readable medium of claim 1 further comprising sending a force tune message to the first subscriber terminal forcing the first subscriber terminal to tune to the first unicast rendition of the program.

8. The computer-readable medium of claim 1 further comprising causing the first unicast rendition of the program to be delivered to the first subscriber by an edge device that also delivers the multicast rendition of the program to the first subscriber terminal.

9. The computer-readable medium of claim 1 wherein the access network is an HFC network and the edge device is a QAM modulator.

10. At least one computer-readable medium encoded with instructions which, when executed by a processor, performs a method including:
monitoring unused bandwidth on an access network between one or more edge devices and a plurality of subscriber terminals; and
receiving a request from a plurality of the subscriber terminals to receive SDV programming over the access network; and
when a sufficient amount of the bandwidth being monitored is available, selecting at least one of the subscriber terminals to receive the SDV programming in a SDV unicast session based at least in part on demographic or other attributes of subscribers associated with each of the subscriber terminals.

11. The computer-readable medium of claim 10 further comprising causing remaining ones of the plurality of subscriber terminals requesting SDV programming to receive a SDV multicast rendition of the SDV programming.

12. The computer-readable medium of claim 11 delivering to a first of the subscriber terminals receiving a SDV unicast session a rendition of the SDV programming that includes advertisements selected at least in part based on the demographic or other attributes of a subscriber associated with the first subscriber terminal.

13. The computer-readable medium of claim 11 wherein the unicast session includes a first rendition of a program and further comprising causing a second of the plurality of subscriber terminals requesting to receive SDV programming to tune to a second SDV unicast when sufficient bandwidth is available on the access network, wherein the second SDV session includes a second rendition of the program.

14. The computer-readable medium of claim 13 further comprising selecting the first and second SDV renditions of the program based at least in part on attributes pertaining to the subscribers associated with each of the subscriber terminals.

15. The computer-readable medium of claim 14 wherein the attributes include demographic information concerning each subscriber.

16. The computer-readable medium of claim 13 wherein the first and second renditions include a common programming and different advertising based at least in part on the attributes pertaining to the subscribers associated with each of the subscriber terminals

17. A switched digital video (SDV) system, comprising:
an SDV manager for coordinating a SDV session requested by a subscriber terminal;
a plurality of edge devices for receiving a transport stream that includes programming content and transmitting the transport stream over an access network to the subscriber terminal on one of a plurality of SDV channels; and
wherein the SDV manager is configured to monitor bandwidth and cause the edge device to deliver the SDV session to the subscriber terminal in a SDV unicast stream when sufficient unused bandwidth is available or as a SDV multicast stream when sufficient unused bandwidth is not available.

18. The switched digital video (SDV) system of claim 17 further comprising a target group database for storing demographic and other attributes associated with individual subscribers and wherein the SDV manager is further configured to cause a rendition of the programming content to be delivered in the SDV unicast stream which is based at least in part on demographic and other attributes of a subscriber associated with the subscriber terminal.

19. The switched digital video (SDV) system of claim 18 wherein the rendition of the programming content delivered in the SDV unicast stream includes advertising targeted to the subscriber.

20. The switched digital video (SDV) system of claim 18 wherein the SDV manager is further configured to cause remaining subscriber terminals requesting SDV programming to receive a SDV multicast rendition of the SDV programming.
